(19) United States
(12) Patent Application Publication
(10) Pub. No.: US 2012/0261500 A1
(43) Pub. Date: Oct. 18, 2012

(54) PORTABLE PAINT SPRAYING DEVICE

(75) Inventors: Elmar KRAYER, Langenargen (DE); Alfred Göhring, Salem (DE); Thomas Jeltsch, Friedrichshafen (DE); Jens Ulbrich, Friedrichshafen (DE); Christoph Welte, Uberlingen (DE)

(73) Assignee: J. Wagner GmbH, Markdorf (DE)

(21) Appl. No.: 13/431,109

(22) Filed: Mar. 27, 2012

Related U.S. Application Data
(63) Continuation of application No. PCT/DE2010/001117, filed on Sep. 23, 2010.

(30) Foreign Application Priority Data
Oct. 2, 2009 (DE) 10 2009 048 022.6

(51) Int. Cl. B05B 3/18

(52) U.S. Cl. 239/722

(57) ABSTRACT

The invention relates to a portable paint spraying device. The device has a paint spraying lance, a base station, and a bundle of hoses.

### CROSS REFERENCE TO RELATED APPLICATIONS

This application is a continuation of International Application No. PCT/DE2010/001117 filed Sep. 23, 2010, which designated the United States, and claims the benefit under 35 USC §119(a)-(d) of German Application No. 10 2009 048 022.6 filed Oct. 2, 2009, the entireties of which are incorporated herein by reference.

### Field of the Invention

The invention relates to a portable paint spraying device.

### BACKGROUND OF THE INVENTION

A large number of air-driven paint spraying devices exist in the prior art and generally comprise a paint reservoir, an apparatus for generating an air stream, for example a compressor or a fan, and a spray gun. Examples include the Wagner FC9900 PC spray station and the Wagner W860 DIY spray station.

There have been constant attempts to improve the devices in terms of their range of use and to design a device which is compact and easy to use.

An arrangement for applying paints is known from DE 10 2007 022 980 A1 and supplies paint to a paint roller. A spray gun is only indicated in the drawing.

DE 10 2008 000 400 A1 also relates to a portable paint spraying device which is compact in design.

A disadvantage of all the prior art devices is that either a paint reservoir has to be attached directly to the spraying apparatus, or the paint is fed to the spraying apparatus via an apparatus which is to be operated separately, and therefore during use a user always has to move with him the weight of the paint or carry with him the base unit itself. This is often considered to be disruptive, particularly when working on a ladder.

### SUMMARY OF THE INVENTION

The object of the invention is therefore to provide a portable paint spraying device which avoids the disadvantages of the prior art.

More specifically, the invention relates to a portable paint spraying device, wherein the paint spraying device comprises a base station having a drive unit and a tubular lance having a first duct for conducting paint and a second duct for conducting an air stream, wherein the drive unit comprises a first working unit for generating an air stream, a second working unit for generating a paint stream, a suction hose for sucking up liquid paint, and a control unit for controlling or adjusting the first unit and the second unit, wherein the lance has an operator unit at a first end, wherein the lance has a spray head at a second end, wherein the lance is connected to the first working unit via an air line, wherein the lance is connected to the second working unit via a paint line, wherein a grip area is arranged between the operator unit and the spray head, it being possible for a user to grip the lance at said grip area, and wherein the operator unit controls at least one of the working units of the drive unit and also operates the discharge of paint at the spray head located at a distance from the operator unit.

A user can thus easily operate a spray head and control a base station while carrying out work, without having to leave his working position. A connection hose of corresponding length between the base station and spraying unit provides a radius of action corresponding to the application.

One development is characterized in that the operator unit controls the working unit for generating a paint stream, wherein said operator unit comprises a first control apparatus, in particular a push switch and a control hose in which an increased control air pressure can be generated, in particular by operating a trigger of the operator unit, and wherein the control unit in particular comprises an electro-pneumatic button arranged in the base station, the control hose being attached to said button and said button being actuated by the control air pressure, and in that the operator unit operates a paint valve mounted in the spray head, wherein the paint valve in particular comprises a paint discharge opening which can be closed by a needle, wherein an operator apparatus is provided for this purpose and is formed in particular as a mechanical movement and force transfer apparatus, with which a movement of a trigger of the operator unit can be converted into a movement of the needle, wherein the movement and force transfer apparatus comprises a pull in particular, preferably a control cable or a Bowden cable, the length of which in particular is adjustable, wherein the movement and force transfer mechanism in particular also comprises a lever in particular, with which the pull, in particular the control cable or Bowden cable, engages and which is connected pivotably to the spray head.

In addition, in a portable paint spraying device according to the invention, it may be that the spray head is first operated upon complete actuation of a trigger of the operator unit and is opened for a discharge of paint, and that at least one of the working units of the drive unit is then started.

In a further expedient embodiment of the invention the at least one working unit of the drive unit is first stopped upon release of a fully actuated trigger of the operator unit, and the spray head is then closed for the discharge of paint.

A further advantageous development is characterized in that the air line and the paint line, which connect the lance to the working units of the base station, are interconnected, wherein the paint line is guided alongside the air line in such a way that the paint line is displaceable relative to the air line, wherein guide means are designed as clips in particular, which surround the air line so it is secured against displacement and surround the paint line loosely, wherein the air line has alternating small and large outer diameters in the longitudinal direction in particular, and the clip is supported on at least one large outer diameter against displacement in the longitudinal direction.

A further embodiment makes it possible for the paint line and the control hose to be formed between the lance and the base station as a one-piece twin hose, wherein the paint line and the control hose have different inner diameters in particular, and wherein the control hose is guided alongside the air line in particular by means of the paint line connected thereto.

The portable paint spraying device according to the invention is characterized in one development in that the first working unit is formed as a fan for generating an air stream, said fan sucking in ambient air through an air filter and conveying it into the spray head through the air hose and the lance, in that the second working unit is formed as a pump, in particular as a hose pump, for generating a paint stream, and in that the control unit for controlling or adjusting the first working unit and the second working unit in particular comprises one selector switch for a conveying output of the hose pump, and in particular one selector switch for operating modes, preferably spraying operation and cleaning operation, wherein the fan is deactivated in cleaning operation and only the pump is operated, in particular at maximum output.

A further expedient embodiment requires that the base station of the paint spraying device comprises a drip pan, in which the lance can be placed together with its spray head, and that the drip pan is removable from the base station for cleaning.

Another expedient embodiment includes the fact that the base station of the paint spraying device is formed substantially by a main body and a pylon, wherein the working units are received in the main body, wherein the pylon comprises a platform arranged at a distance above the main body and, in particular, comprises two struts, wherein the struts carry the platform and are connected to the main body, wherein the platform comprises a retaining clip for the lance, wherein the retaining clip is linked to the platform, in particular so as to be pivotable about a horizontal axis, and wherein the retaining clip in particular comprises a first coupling means in particular, wherein the first coupling means is formed as a bore in particular, wherein the first coupling means can be coupled to a second coupling means, wherein the second coupling means is arranged on the lance or is associated with the lance and in particular is formed as a pin, and wherein the lance, when gripped by the retaining clip, is positioned with its spray head in the drip pan in particular.

In an expedient development the selector switches of the control unit are arranged in the platform.

In a further expedient embodiment the paint hose, which connects a paint outlet of the base station to a paint inlet of the spray head, is secured at the paint outlet with a greater pull-off force than at the paint inlet of the spray head.

In addition, one development is characterized in that the air filter is arranged in particular on an upper face of the main body of the base station and is covered by a protective grid, wherein the protective grid is formed in particular in one piece with the drip pan.

In particular, the invention relates to a portable paint spraying device and to a development in which the air stream volume and the air pressure at the spray head correspond to the HVLP (high volume low pressure) threshold values, and in particular a pressure of approximately 10 psi (approximately 0.7 bar) is not exceeded. Reference is hereby made to the provisions regarding HVLP technology.

In particular, the portable paint spraying device according to the invention has different operating modes, which can be selected by the user and can be implemented temporarily, complementarily or fully according to the stage of development of the device. In particular, the operating modes concern the following controls of the drive unit and arrangements of the device components:

a) paint spraying operation: The paint spraying lance is held by the user, an air conveying unit, in particular a fan, in the drive unit conveys air to generate and apply a paint mist, the working unit of the drive unit provided to convey paint conveys a defined paint volume to the paint spraying lance, preferably at variable speed, wherein the working unit is preferably formed as a continuously operating hose pump.

b) emptying operation: For environmental reasons, to save the cost of consumables, and for simplified cleaning, the working unit formed as a paint pump can preferably be operated at limited or at maximum conveying output in the reverse conveying direction so as to convey paint in the device back into a paint reservoir. This can be carried out whether the lance is held by the user or is housed in a retaining clip on the base station. The air conveying device can be deactivated in this operating mode.

c) cleaning operation: The user can either hold the lance in a cleaning vessel, preferably in a bucket, or he can orientate the lance, whilst it is retained, via its front end in a direction pointing away from the base station by pivoting the retaining clip on the base station so that the tip of the lance points or protrudes into a container placed in front of the base station. A container containing cleaning fluid, preferably water, is arranged on the paint feed side and is to be conveyed at least in part through the paint conveying path of the paint spraying device for cleaning thereof. The air conveying device is deactivated in this operating mode. The working unit for paint conveyance can be operated continuously or in a pulsed manner at limited or maximum conveying output.

In a preferred embodiment of the portable paint spraying device, the first working unit for generating an air stream can be controlled, and in particular can be adjusted, to change the air stream flow. It is often sensible to adjust the air stream volume provided in order to improve the spray pattern, since different processed materials, for example wall paints made by different manufacturers, cannot always be sprayed optimally with identical processing parameters. For example a high air stream flow leads to increased overspray, which means increased misting of the paint in the surrounding environment. This can be counteracted by reducing the air stream flow.

In a respective development of the portable paint spraying device, the air stream flow is controlled or adjusted in predefined stages, in particular programs, and/or can be set continuously, wherein a resultant control or adjustment of the second working unit is preferably provided, in particular via the control unit.

The provision of control or adjustment stages for the air stream flow offers increased operating comfort and helps the user to find the correct settings. In addition, predefined programs can be specified for example, which contain the optimal parameters for specific paints to be sprayed, for example in accordance with a manufacturer's table or in accordance with viscosity data. The possibility of influencing the output of the second working unit, which provides the paint flow, as a result of the detected setting of the air stream flow means the user also no longer has to manually adjust the amount of provided paint to the air stream flow.

Of course, in a sort of “professional mode” the user is also allowed to provide a continuous adjustment of the air stream flow in individual settings, either alternatively or additionally.

An embodiment according to the invention of a portable paint spraying device is provided in the following exemplary embodiment. However, the invention is not restricted to the exemplary embodiment. Rather, it includes all embodiments which make use of the concept essential to the invention.

### BRIEF DESCRIPTION OF THE DRAWINGS

FIG. 1 shows a perspective illustration of a paint spraying device according to the invention;

FIG. 2 shows a front view of the base station;

FIG. 3 shows a rear view of the base station;

FIG. 4 shows a side view of the spraying lance;

FIG. 5 shows a schematic cross-section through the bundle of lines or hoses with a retaining clip;

FIG. 6 shows a side view of the paint spraying device;

FIG. 7 shows an illustration of the clip for connecting the individual hoses or lines; and

FIG. 8 shows a clip according to FIG. 7 with inserted hoses.

### DETAILED DESCRIPTION OF THE INVENTION

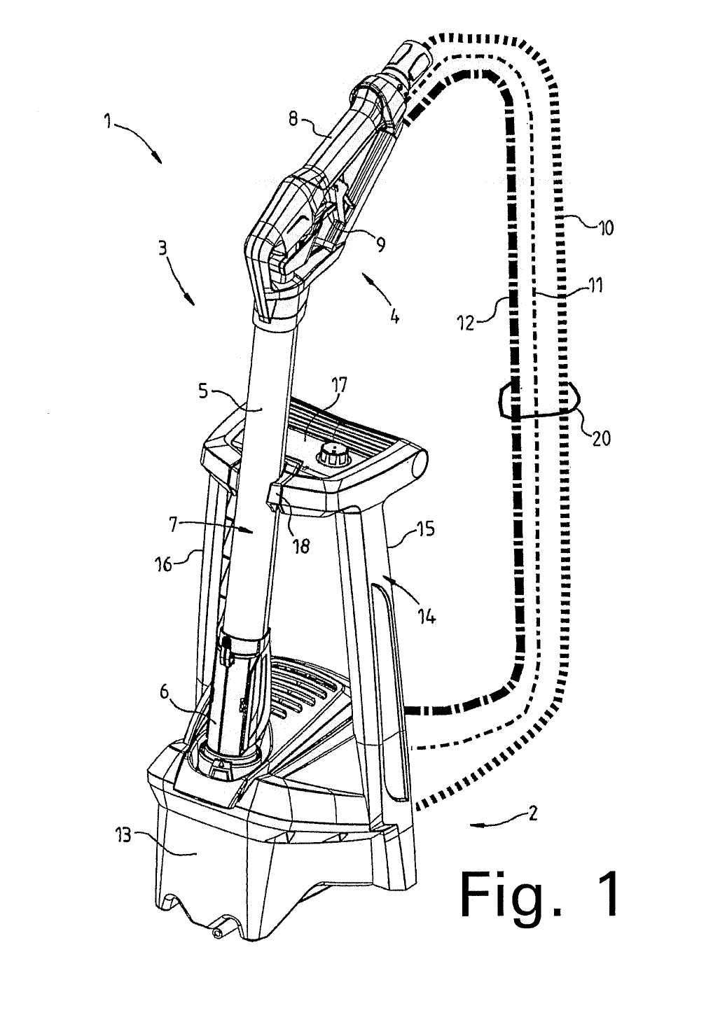

More specifically, FIG. 1 shows a perspective illustration of a paint spraying device 1 according to the invention. The paint spraying device comprises a base station 2 and a paint spraying lance 3, which are connected by a number of lines or hoses.

The paint spraying lance 3 has an operator unit 4 at its upper end, said operator unit leading into a lance part 5, and comprises at the front end of the lance part 5 a spray head 6 for dispensing the paint to be sprayed. The lance part 5 forms a grip area 7, via which the lance can be handled. A handle 8 is provided on the operator unit 4, a trigger 9 for releasing or operating the paint spraying device being provided in the region of said handle.

Different bundles of hoses or lines leave the paint spraying lance 3 at the end of the handle 8 remote from the lance 5 of the paint spraying lance 3. On the one hand, the paint spraying lance 3 is connected to the base station 2 by an air line 10, and on the other hand a control hose 11 and a paint line 12 are also arranged between the paint spraying lance 3 and the base station 2. The air line 10 is used to provide air for the paint spraying process, the paint line 12 is used to provide the paint to be applied, and the control line 11 or the control hose 11 is used to control the working unit of the drive unit arranged in the base station 2.

The base station 2 comprises a main body 13, in which the drive unit for the paint spraying device 1 is housed. A pylon 14, which holds a platform 17 arranged above the main body 13 by two struts 15, 16 is fitted on the main body 13. Elements arranged in or on the platform 17 are thus brought closer to a user so that he can reach them without stooping and without carrying out a corresponding uncomfortable movement.

A retaining clip 18 for clamping and retaining the paint spraying lance 3, in particular the lance body 5, is arranged on the platform 17 in a region of the front face of the device. The retaining clip 18 is designed in such a way that the paint spraying lance 3 can be inserted in any direction, but preferably in the position directed forwards or backwards, based on the orientation of the operator unit 4, and in particular of the handle 8.

A retaining clip 20 is provided on the bundle of hoses formed of the air line 10, control line 11 and paint line 12, said retaining clip uniting the individual lines or hoses to form a unit. A plurality of retaining clips 20 may also be provided over the entire line course according to the length of the individual lines 10, 11, 12.

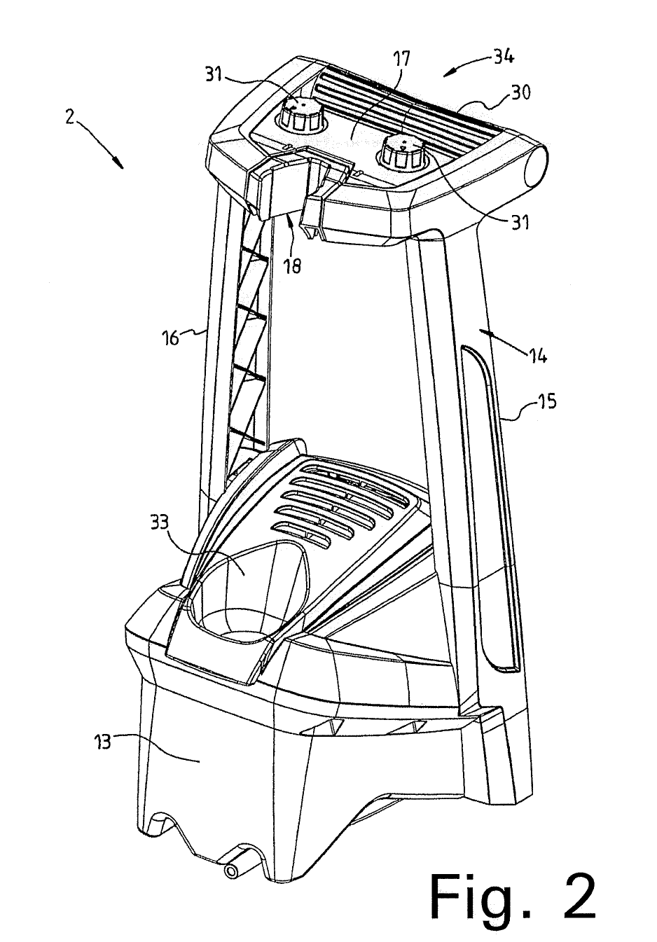

FIG. 2 shows a front view of the base station 2 with no illustration of the paint spraying lance and lines. In its lower region, the base station 2 comprises the main body 13 and, standing thereon, the struts 15, 16 for forming the pylon 14, on the upper end of which the platform 17 is arranged. A handle 30 is provided on the rear region of the platform 17 and is intended to develop the station into an easily portable unit. Selector switches 31 are arranged on the platform and, on the one hand, can provide different operating functions, but on the other hand can also be used to control the corresponding working units, for example of the paint conveying pump or of the fan. The selector switches can either be formed as rotary switches 31, or can also include other arrangements, for example in the form of flip switches.

The retaining clip 18 is arranged on the front face of the platform 17 and is adapted in terms of its shape to the corresponding outer shape of the lance 5. A drip pan 33 is arranged in the main body 13 of the base station 2 and is preferably formed as a removable component which is therefore easy to clean.

The upper part of the platform 17 forms the control unit 34 together with any electronic switches which may be housed in the main body 13, and is provided to control the respective function and working parameters of the paint spraying device 1 according to the invention.

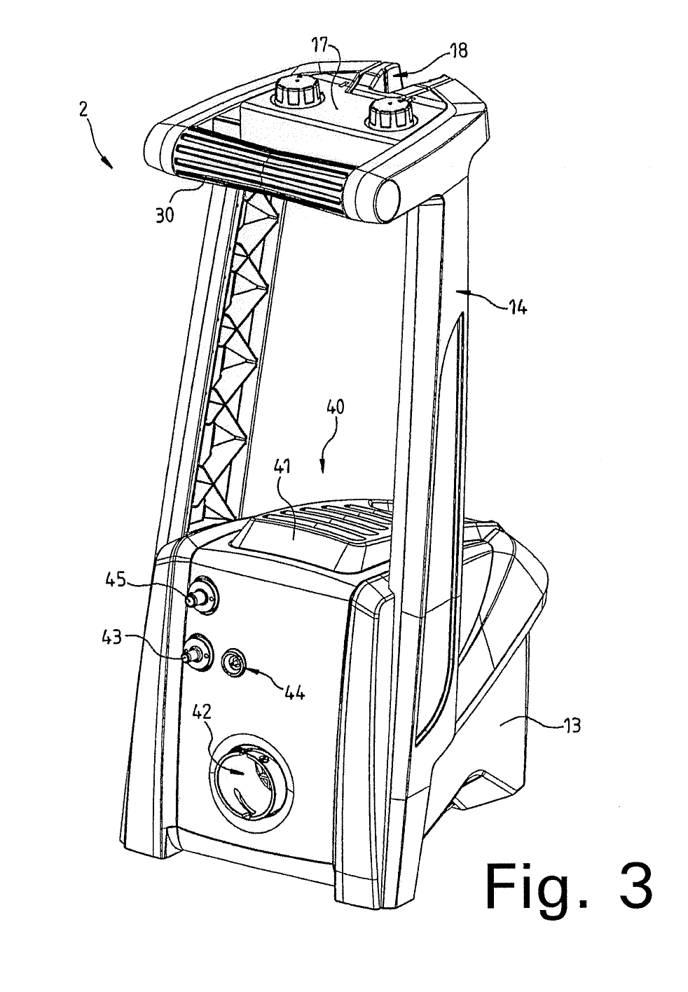

FIG. 3 shows a rear view of the base station 2, likewise with no illustration of the paint spraying lance 3 and corresponding lines.

The base station 2 has inlet openings 40 in its upper face with an air filter arranged behind so as to convey a corresponding air volume for the provision of the process air. The covering cap 41 arranged for this purpose may optionally be removed together with the drip pan 33 so as to enable easy and frequent access to the air filter.

Different connection apparatuses are located on the rear face in the region of the main body 13 of the base station 2 and are provided for connection of the air line 10, the control hose 11, and the paint line 12. The air output 42 for connection of the air line 10 is arranged at the lowest point on the device side and has an increased cross-section compared to the other connection regions. The air output 42 may be equipped with a bayonet catch to enable simple attachment and removal of the air line 10.

A paint input 45 to which a connection hose can be attached is located above the air output 42, for example, it being possible to insert said connection hose into a paint bucket or paint tank next to the device, thus enabling simple removal from the supply container of the paint to be sprayed.

The control air hose input 44 is provided beneath the paint input 45, has a smaller cross-section and is only used to transfer a pneumatic control signal, which starts from the operator unit 4, actuated via the trigger 9 of the paint spraying lance 3.

The paint outlet 43 for attachment of the paint line 12 is located beneath the paint input 45, said paint line then transporting the paint sucked up by the base station 2 or by the working units located therein from the paint input 45, via the paint outlet 43 and the paint line 12 to the spray head 6.

The control hose input 44 leads into an electro-pneumatic switching apparatus which, with control pressure present in the control hose 11, activates the paint pump between the paint input 45 and the paint outlet 43 so that paint is conveyed to the paint spraying lance 3 and to the paint spraying head 6. The electro-pneumatic switch is preferably formed as a button so that, when the trigger 9 on the operator unit 4 is released, a corresponding fall in pressure in the control line 11 automatically leads to disconnection of the paint pump.

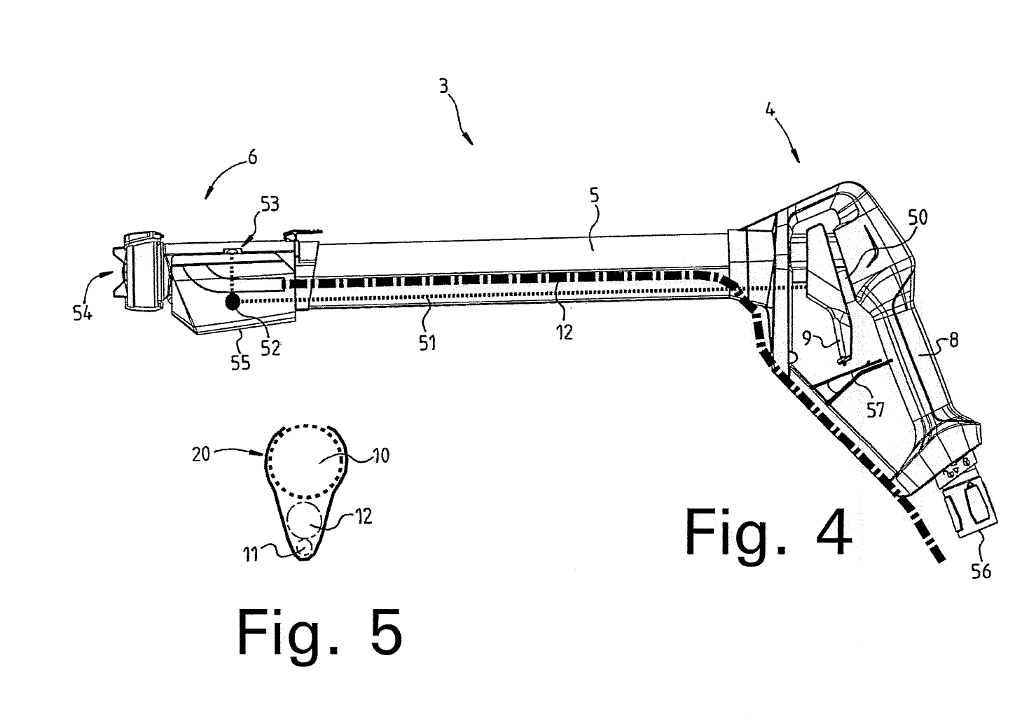

FIG. 4 shows a schematic illustration of a side view of the paint spraying lance 3 according to the invention.

The operator unit 4 comprises the handle 8 and a trigger 9, which can exert pressure on its rear face onto a push switch 50. The push switch may be formed in this instance as a bellows-like pneumatic pressure generator, or may comprise a piston-cylinder mechanism.

A force transfer means 51 in the form of a pull is illustrated on the front face of the trigger 9 and, for example, may be formed for example as a control cable. The control cable 51 transfers the movement of the trigger 9 to the needle of a needle valve 53 (not illustrated in detail in this instance) via a corresponding deflection mechanism 52, said needle valve then allowing paint to discharge from a paint nozzle 54. The paint is provided from the base device to the paint nozzle via the paint line 12. The paint nozzle is preferably formed as a slit-like nozzle, as is described in another patent application filed by the applicant.

In an advantageous embodiment the spray head 6 has a cover 55 which covers the front mechanically moved regions of the deflector 52 and of the needle valve 53, including the apparatus for force transfer 51. During operation of the paint spraying lance 3 according to the invention, a user clasps the grip 8 with one hand so that he can easily operate the trigger 9 using his finger. The lance 5 may also be clasped by his second hand so that the spray head can be guided along a surface to be coated or to be sprayed in a simple and targeted, but above all uniform, manner. Furthermore, the formation of the paint spraying lance 3 over a corresponding length of the lance component 5 offers the possibility of coating larger areas uniformly from a single position due to a corresponding distancing and resultant radius of action so that a considerably improved result can be achieved in the field of coating walls with wall paint. The painting of building roofs or more distant building parts does not pose a great problem due to different lance lengths of the lance component 5 and accordingly adapted lines 12 and force transfer apparatuses 51.

The operator unit 4 has an air hose connection 56 on its lower end of the grip 8, said connection likewise possibly being present in the form of a removable bayonet catch so as to enable simple disassembly of the air line 10.

In the present case, the paint line 12 is preferably guided in a front frame part of the operator unit 4 so that it leaves the operator unit 4 from beneath, parallel to the air hose connection 56.

The operator unit 4 also has a spring 57 in a region beneath the trigger 9, said spring enabling the trigger 9 to be locked in a pulled state, the spring being pressed upwardly by a catch and being fixed in a corresponding catch on the trigger 9.

FIG. 5 shows a schematic illustration of a clip 20 according to the invention which holds together the bundle of lines or hoses formed of the air line 10, paint hose 12 and the control hose 11 in the region between the paint spraying lance 3 and the base station 2. With a corresponding design of the air line 10 as a corrugated hose, it is possible for the clip 20 to engage in the corrugation of the air line 10 and to thus adopt a fixed position on the air line hose 10 in the longitudinal direction. The paint hose 12 and the control hose 11 can be formed as a twin hose, and can be produced either side by side or running one inside the other as a continuous product. There is no fixed connection in the longitudinal direction between the air line 10 and the paint hose 12 or the paint hose 12 and control hose 11 bundle, since the air line hose 10 is expanded during operation by a corresponding heating of the process air and the resultant heating of the air line 10, and the paint line 12 heated to a lesser extent and the other lines which expand to a lesser extent can thus slide alongside the air line 10.

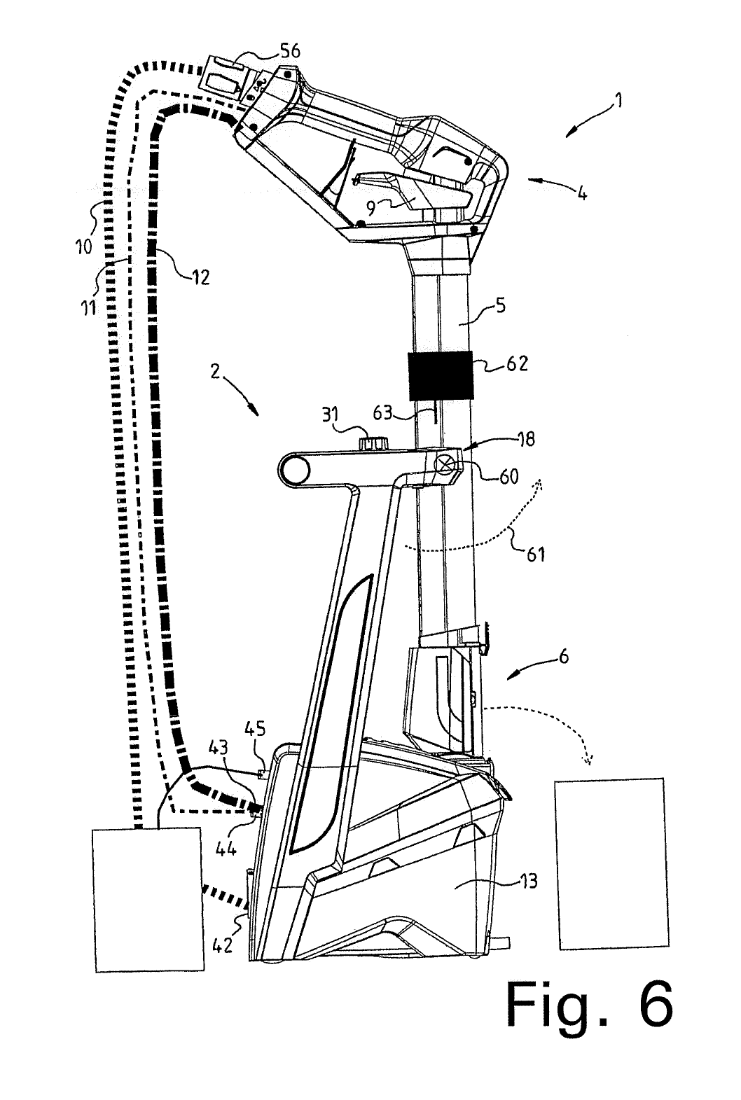

FIG. 6 shows a side illustration of the paint spraying device 1 according to the invention with the paint spraying lance 3 arranged in the retaining clip 18. The retaining clip 18 has a pivot pin 60 for providing a cleaning function, the retaining clip 18 being pivotable about said pivot pin by way of a pivoting motion 61 so that the paint lance 3 retained therein can be tilted via its lance component 5 in accordance with the pivoting motion 61. In order to prevent the paint spraying lance 3 from slipping out when pivoted along the pivoting motion 61, a coupling means 62 is provided which has a pin 63 at a lower end, preferably on either side of the coupling means 62, which can be inserted into a corresponding bore in the retaining clip 18 provided for this purpose (not illustrated in this instance) and thus prevents the paint spraying lance 3 from slipping or falling out from the retaining clip 18 in a pivoted state. In addition, the coupling means is also used to secure and fix the paint spraying lance 3 on the base device 2 in a vertical storage position, and in particular on the handle 30 during transport of the entire device. A vessel, for example an empty bucket, can be provided in front of the main body 13 of the base device 2 for the cleaning function, the cleaning fluid conveyed through the paint spraying device in accordance with the cleaning process being able to run into said bucket. Instead of a paint reservoir, a reservoir containing cleaning fluid for example, preferably water, may be attached to the paint feed connection on the base device 2 (see FIG. 3, reference sign 45), wherein the cleaning fluid can be conveyed by the paint pump through the device and through the paint line 12 and through the arrangements of the paint spraying lance 3, in particular the paint spraying head 6 and the paint nozzle 54, when the fan is switched off as a result of a corresponding setting of the selector switch 31, and can be collected in the aforementioned cleaning reservoir arranged in front of the main body 13 once the device has been cleaned.

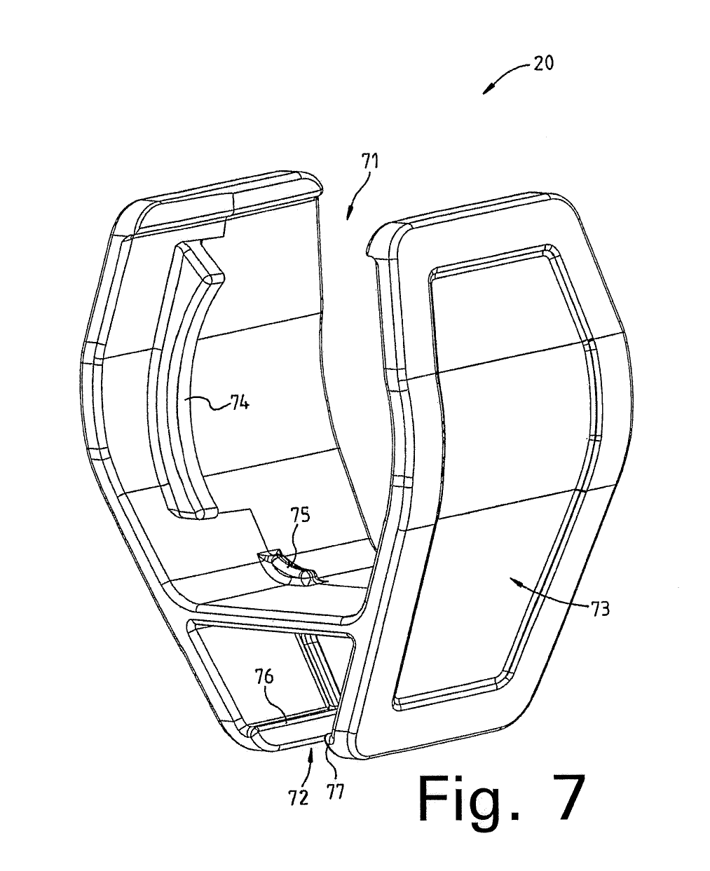

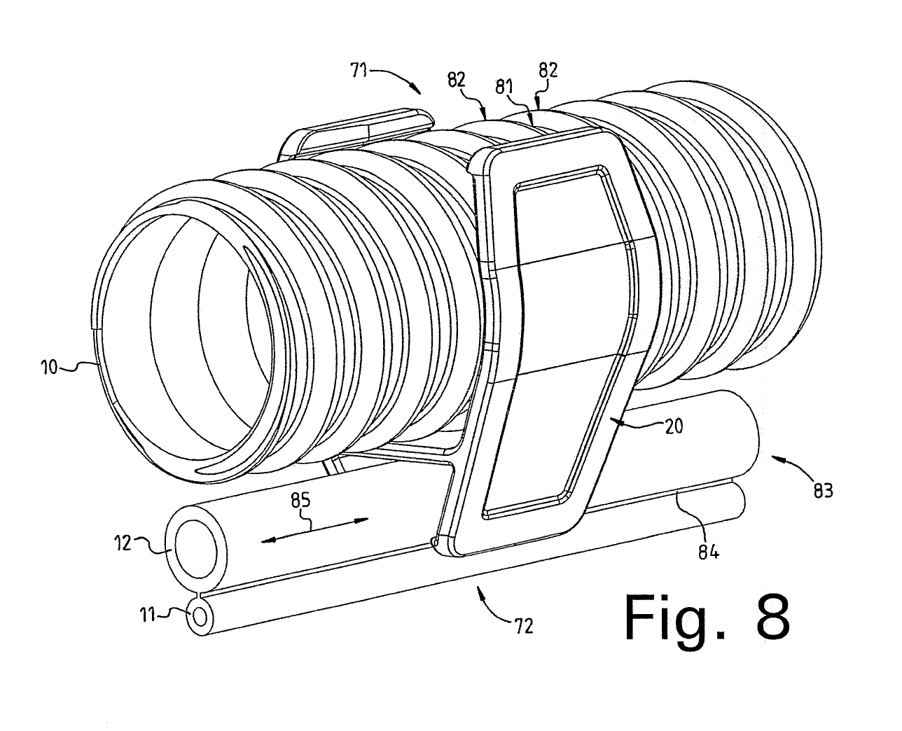

FIG. 7 shows a connecting clip 20, which is used between the base station 2 and the paint spraying lance 3 to produce a connection between the air hose, control hose and paint hose at the bundle of hoses. The clip 20 comprises an upper clamping region 71 for receiving the air hose and a lower clamping region 72 for receiving the paint and control hose. Information such as attachment and assembly instructions or company name or logo can be arranged on the side faces 73 so as to be easily visible.

The upper clamping region 71 has a plurality of protrusions 74 and 75 on its inner face which are used to engage in a grooved sheathing of an air line/air hose so as to hold the clip 20 rigidly thereagainst in the longitudinal direction. The protrusions 74, 75 can be adapted ergonomically to the shape of the hose or the shape of the grooves so as to achieve particularly good guidance, whereby the clip can also be rotated about the longitudinal axis of the air line.

Latching elements 76, 77 are provided in the lower clamping region 72 at the lower end thereof and engage from behind the hose inserted into the lower clamping region and, with a positive fit, secure it against falling out.

The lower clamping region 72 and the upper clamping region 71 can be formed as flexible, resilient side arms, or the hoses to be retained are inserted by elastic deformation of the individual hoses during the insertion process.

FIG. 8 shows a clip 20 according to FIG. 7, in which a section of a bundle of hoses to be retained is illustrated. The clip 20 is latched rigidly onto an air hose 10 in the longitudinal direction via its upper clamping region 71, the protrusions 74 and 75 being embedded in the grooves of the air hose. The protrusions engage in a region of small outer diameter 81, which is defined by a region of large outer diameter 82 along the longitudinal direction of the hose.

A paint hose 12 and a control hose 11 in the form of a twin hose 83 are illustrated in the lower clamping region 72. The hoses 11 and 12 are interconnected longitudinally via a web along the hose length, wherein the hoses can be separated from one another by separating the web in the region of the assembly position on the paint spraying lance 3 and the base station 2 so as to reach different connections or so as to be cut to different lengths.

The twin hose 83 is held movably in the lower clamping region 72 by engagement of the latching elements 76 and 77 in the web region 84, in such a way that the twin hose can slide along the longitudinal direction 85. This is necessary in particular if a bundle of hoses measuring a number of meters in length is provided and the air conveyed in the air hose 10 is heated in the fan of the base station 2, since the air hose 10 is also heated and consequently expands. In addition, rigid fastenings in the upper clamping region 71 and in the lower clamping region 72 would lead to an undesired stiffening of the bundle of hoses, which would conflict with handling comfort.

The individual operating modes are given in the table below:

| | Position | | | | |
|---|---|---|---|---|---|
| | of the | | | | Paint |
| Operating | paint | Paint | Trigger | Fan for air | conveying |
| mode | lance | connection | setting | conveyance | pump |
| Paint | User | Paint | Manually | Controlled | Controlled |
| spraying | | reservoir | operated | or full | output |
| operation | | (bucket) | | output | |
| Emptying | User or | Paint | Manually | Deactivated | Controlled |
| | in the | reservoir | operated | | or full |
| | retaining | (bucket) | or | | output in |
| | clip on | | locked | | reverse |
| | the base | | by the | | conveying |
| | station | | catch | | direction |
| | | | spring | | |
| Cleaning | Retaining | Cleaning | Locked | Deactivated | Controlled |
| | clip on | fluid | by the | | or full |
| | the base | (water) | catch | | output, |
| | station, | | spring | | continuous |
| | pivoted | | | | or pulsed. |
| | forwards | | | | |
| | out of | | | | |
| | the drip | | | | |
| | bowl and | | | | |
| | directed | | | | |
| | towards | | | | |
| | the | | | | |
| | cleaning | | | | |
| | container | | | | |

### LIST OF REFERENCE SIGNS

1 paint spraying device
2 base station
3 paint spraying lance
4 operator unit
5 lance
6 spray head
7 grip area
8 handle on the paint spraying lance
9 trigger
10 air line
11 control hose
12 paint line
13 main body
14 pylon
15 strut
16 strut
17 platform
18 retaining clip
20 clip
30 handle on the base station
31 selector switch
33 drip pan
34 control unit
40 inlet openings
41 covering cap
42 air output
43 paint outlet
44 control hose input
45 paint input
50 push switch
51 force transfer
52 deflector
53 needle valve
54 paint nozzle
55 cover
56 air hose connection
57 spring
60 pivot pin
61 pivoting motion
62 coupling means
63 pin
71 upper clamping region
72 lower clamping region
73 side face
74 protrusion
75 protrusion
76 latching element
77 latching element
81 small outer diameter
82 large outer diameter
83 twin hose
84 web
85 longitudinal direction/sliding direction

1. A portable paint spraying device,comprising a base station having a drive unit and a tubular lance having a first duct for conducting paint and a second duct for conducting an air stream,
wherein the drive unit comprises
a first working unit for generating an air stream,
a second working unit for generating a paint stream and having a, suction hose for sucking up liquid paint, and
a control unit for controlling or adjusting the first unit and the second unit, wherein the lance comprises
an operator unit at a first end,
a spray head at a second end,and
a grip area arranged between the operator unit and the spray head, it being possible for a user to grip the lance at said grip area,
wherein the lance is connected to the first working unit via an air line,
wherein the lance is connected to the second working unit via a paint line, and
wherein the operator unit controls at least one of the working units of the drive unit and also operates the discharge of paint at the spray head located at a distance from the operator unit.

2. The portable paint spraying device as claimed in claim 1, wherein the operator unit controls the working unit for generating a paint stream, wherein the operator unit comprises a first control apparatus in the form of a push switch with a control hose in which an increased control air pressure can be generated by operating a trigger of the operator unit, and wherein the control unit comprises an electro-pneumatic button arranged in the base station, the control hose being attached to said button and said button being actuated by the control air pressure, and wherein the operator unit operates a paint valve mounted in the spray head, wherein the paint valve comprises a paint discharge opening which can be closed by a needle, wherein an operator apparatus is provided for this purpose and is formed as a mechanical movement and force transfer apparatus, with which a movement of a trigger of the operator unit can be converted into a movement of the needle, wherein the movement and force transfer apparatus comprises a control cable or a Bowden cable, the length of which is adjustable, wherein the movement and force transfer mechanism further comprises a lever, with which the control cable or Bowden cable engages, and which is connected pivotably to the spray head.

3. The portable paint spraying device as claimed in claim 1, wherein the operator unit is dimensioned in such a way that the spray head is first operated upon complete actuation of a trigger of the operator unit and is opened for a discharge of paint, and at least one of the working units of the drive unit is then started.

4. The portable paint spraying device as claimed in claim 1, wherein the at least one working unit of the drive unit is first stopped upon release of a fully actuated trigger of the operator unit, and the spray head is then closed for the discharge of paint.

5. The portable paint spraying device as claimed in claim 1, wherein the air line and the paint line, which connect the lance to the working units of the base station, are interconnected, wherein the paint line is guided alongside the air line in such a way that the paint line is displaceable relative to the air line, wherein clips surround the air line so it is secured against displacement and surround the paint line loosely, wherein the air line has alternating small and large outer diameters in the longitudinal direction in particular, and the clip is supported on at least one large outer diameter against displacement in the longitudinal direction.

6. The portable paint spraying device as claimed in claim 2, wherein the paint line and the control hose are formed between the lance and the base station as a one-piece twin hose, wherein the paint line and the control hose have different inner diameters in particular, and wherein the control hose is guided alongside the air line in particular by means of the paint line connected thereto.

7. The portable paint spraying device as claimed in claim 1, wherein the first working unit is formed as a fan for generating an air stream, said fan sucking up ambient air through an air filter and conveying it into the spray head through the air hose and the lance, wherein the second working unit is formed as a hose pump for generating a paint stream, and wherein the control unit for controlling or adjusting the first working unit and the second working unit comprises one selector switch for a conveying output of the hose pump, and one selector switch for changing operating modes between spraying operation and cleaning operation, wherein the fan is deactivated during the cleaning operation and only the pump is operated at maximum output.

8. The portable paint spraying device as claimed in claim 1, wherein the base station of the paint spraying device comprises a drip pan, in which the lance can be placed together with its spray head, and wherein the drip pan is removable from the base station for cleaning.

9. The portable paint spraying device as claimed in claim 8, wherein the base station of the paint spraying device is formed substantially by a main body and a pylon, wherein the working units are received in the main body, wherein the pylon comprises a platform arranged at a distance above the main body and comprises two struts that carry the platform and are connected to the main body, wherein the platform comprises a retaining clip for the lance, wherein the retaining clip is linked to the platform so as to be pivotable about a horizontal axis, and wherein the retaining clip comprises a first coupling mechanism formed as a bore, wherein the first coupling mechanism can be coupled to a second coupling mechanism arranged on the lance or associated with the lance and formed as a pin, and wherein the lance, when gripped by the retaining clip, is positioned with its spray head in the drip pan.

10. The portable paint spraying device as claimed in claim 9, wherein the at least one selector switch of the control unit is arranged in the platform.

11. The portable paint spraying device as claimed in claim 1, wherein the paint hose, which connects a paint outlet of the base station to a paint inlet of the spray head, is secured at the paint outlet with a greater pull-off force than at the paint inlet of the spray head.

12. The portable paint spraying device as claimed in claim 1, wherein an air filter is arranged on an upper face of a main body of the base station and is covered by a protective grid that is formed in one piece with a drip pan.

13. The portable paint spraying device as claimed in claim 1, wherein the air stream volume and the air pressure at the spray head correspond to the HVLP threshold values, and a pressure of approximately 10 psi is not exceeded.

14. The portable paint spraying device as claimed in claim 1, wherein the first working unit for generating an air stream can be adjusted to change the air stream flow.

15. The portable paint spraying device according to claim 14, wherein the air stream flow is adjusted in predefined stages or can be set continuously, wherein a resultant adjustment of the second working unit is provided via the control unit.
